(19) United States
(12) Patent Application Publication
(10) Pub. No.: US 2003/0193303 A1
(43) Pub. Date: Oct. 16, 2003

(54) Deflection yoke

(75) Inventors: Hyun Sig Doo, Suwon-Shi (KR); Sung Woon Kim, Anyang-Shi (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/255,231

(22) Filed: Sep. 25, 2002

(30) Foreign Application Priority Data
Apr. 16, 2002 (KR) 2002-20555

(51) Int. Cl. G09G 1/04

(52) U.S. Cl. 315/370; 315/382

(57) ABSTRACT

Disclosed is a deflection yoke which provides a structure for uniformly supporting a PCB on a rear cover of the deflection yoke in order to prevent any damage due to the assembling force when the PCB is assembled onto the rear cover.

### BACKGROUND OF THE INVENTION

1. Field of the Invention

The present invention relates to a deflection yoke, in particular, which provides an improved structure of a PCB in order to prevent any damage due to assembling force.

2. Description of the Related Art

In general, a Cathode Ray Tube (CRT) in a television or a monitor has a deflection yoke for correctly deflecting RGB beams scanned from an electron gun toward a fluorescent screen applied on a screen of the CRT. Such a deflection yoke functions as one of the most important magnetic components in the CRT to deflect the electron beams from the electron gun so that electric signals transmitted in time sequence can be reproduced as images on the screen of the CRT.

In other words, since the electron beams projected from the electron gun linearly move toward the screen under a high voltage to light only central phosphors in the screen, the deflection yoke externally deflects the electron beams in the order of scanning. The deflection yoke generates a magnetic field to deflect the electron beams correctly onto the fluorescent screen applied on the screen of the CRT based upon the fact that the electrons change their courses when they are forced from the magnetic field while passing through the same.

FIG. 1 is a side elevation view illustrating a general CRT. As shown in FIG. 1, a deflection yoke 4 is placed in an RGB electron gun section 3 of the CRT 1 to deflect electron beams scanned from an electron gun 3a toward a fluorescent screen applied on a screen surface 2.

Such a deflection yoke 4 comprises a coil separator 10 constituted of a pair of symmetric upper and lower parts which are coupled into one unit. The coil separator 10 is provided to mutually insulate horizontal deflection coils 15 and vertical deflection coils 16 while assembling the same in place, and comprised of a screen section 11a for coupling with one side of a screen surface of the CRT 1, a rear cover 11b and a neck section 12 integrally extended from a central surface of the rear cover 11b for coupling with the electron gun section 3 of the CRT 1.

In the inner and outer peripheries of the coil separator 10, the horizontal deflection coils 15 and the vertical deflection coils 16 are respectively provided to generate horizontal and vertical magnetic deflections with an external power source.

Further, a pair of ferrite cores 14 are installed to wrap the vertical deflection coils 16. The ferrite cores 14 are made of a magnetic substance to strengthen the vertical magnetic deflection generated from the vertical deflection coils 16.

The deflection yoke configured as above is provided at one side with a Printed Circuit Board (PCB; not shown) to electrically connect with the horizontal deflection coils, the vertical deflection coils and various electric equipments.

FIGS. 2 and 3 are front elevation views illustrating a coil separator coupled with a PCB of the prior art.

As shown in FIGS. 2 and 3, the PCB 200 has slide grooves 210 provided in the upper section with a predetermined interval and through-holes 220 distanced under the slide grooves 210 with a certain space, in which the slide grooves 210 and the through-holes 220 are generally provided in pairs.

In the meantime, the slide grooves 210 are U-shaped as shown in FIG. 3, and the through-holes 220 are substantially quadrangular.

The PCB 200 is coupled with a number of hook pieces provided on a rear cover 11b, in which the hook pieces are constituted of upper hook pieces 310 and lower hook pieces 320 provided in positions corresponding to the slide grooves 210 and the through holes 220.

The upper hook pieces 310 and the lower hook pieces 320 constructed as above are fit into the slide grooves 210 and the through holes 220 to fix the PCB 200 onto the rear cover 11b.

In the meantime, the upper hook pieces 310 and the lower hook pieces 320 are provided in positions which are substantially in the range of the diameter of the neck section 12.

However, such a conventional deflection yoke has a drawback that the PCB 20 is easily damaged at both ends due to the assembling force of a worker when it is assembled to the rear cover 11b as shown in FIG. 3. Since the pair of the upper hooks 310 and lower hooks 320 applying a supporting force to the PCB 200 are constructed within the diameter of the neck section 12, the PCB 200 having the upper and lower hooks 310 and 320 is applied at a central portion thereof with the stable supporting force, but not at both sides of the upper end thereof. So, the both sides of the upper end are easily cracked and broken.

Therefore, the worker is required to carry out the assembly work while heavily paying attention not to damage the upper both ends of the PCB 200 so that the workability and the productivity are degraded as a problem.

### SUMMARY OF THE INVENTION

Accordingly the present invention has been made to solve the above problems of the prior art and it is an object of the invention to provide a deflection yoke capable of securely supporting upper both ends of a PCB to prevent any damage due to the assembling force thereby to improve the assembling ability and the productivity.

According to an aspect of the invention to obtain the above objects, it is provided a deflection yoke comprising: a coil separator having a screen section, a rear cover, the screen section and the rear cover being coupled to one side of a screen surface of a CRT, and a neck section extended from a central face of the rear cover for coupling with an electric gun section of the CRT; horizontal and vertical deflection coils provided in inner and outer peripheries of the coil separator for generating horizontal and vertical magnetic deflections; a plurality of fixtures projecting from sides of the rear cover with intervals proportional to the diameter of the neck section; a PCB having a plurality of holes in positions corresponding to the fixtures for receiving the same, the PCB electrically connecting the horizontal deflection coils and the vertical deflection coils; and a plurality of support pieces projecting from the sides of the rear cover having the fixtures projecting therefrom and with projected distal ends contacting with a side of the PCB for applying a supporting force.

The invention is preferably characterized in that the fixtures are upper and lower hook pieces which are arranged with a vertical interval.

Preferably, the invention is also characterized in that the plurality of holes in the PCB are slide-grooves recessed from edges and through-holes arranged under the slide grooves with an interval.

Also, the invention is preferably characterized in that the support pieces are provided in positions adjacent to edges of the rear cover at sides of the fixtures.

Preferably, the invention is also characterized in that the support pieces are provided in a pair for respectively supporting both sides of an upper part of the PCB.

Preferably, the invention is also characterized in that the support pieces are integral to the rear cover.

### BRIEF DESCRIPTION OF THE DRAWINGS

FIG. 1 is a side elevation view illustrating a CRT adopting a general deflection yoke;

FIGS. 2 and 3 are front elevation views illustrating the assembled position of a PCB in a deflection yoke of the prior art; and

FIGS. 4 and 5 illustrate the assembled posture of a PCB in a deflection yoke of the invention.

### DETAILED DESCRIPTION OF THE PREFERRED EMBODIMENT

The following detailed description will present a preferred embodiment of the invention in reference to the accompanying drawings.

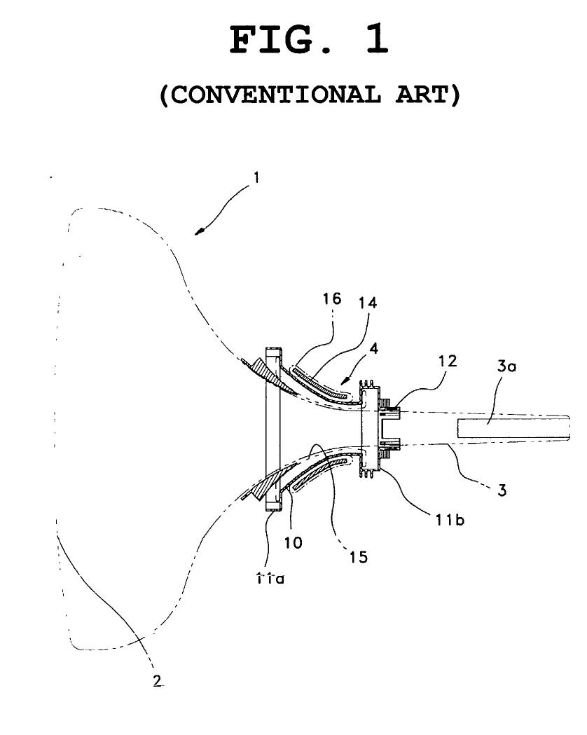

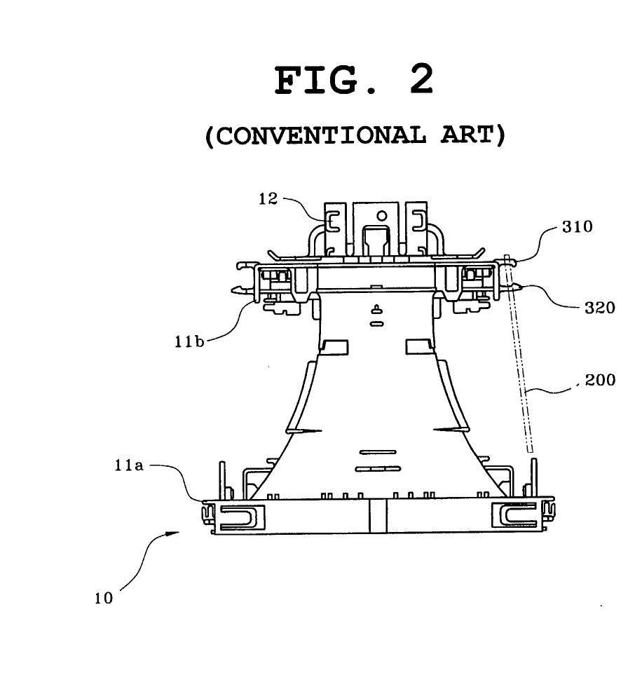

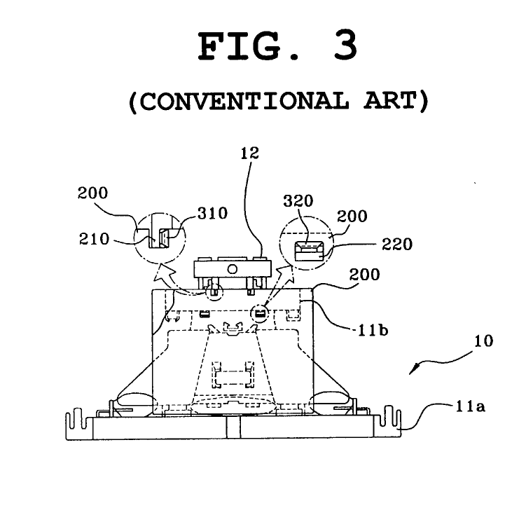

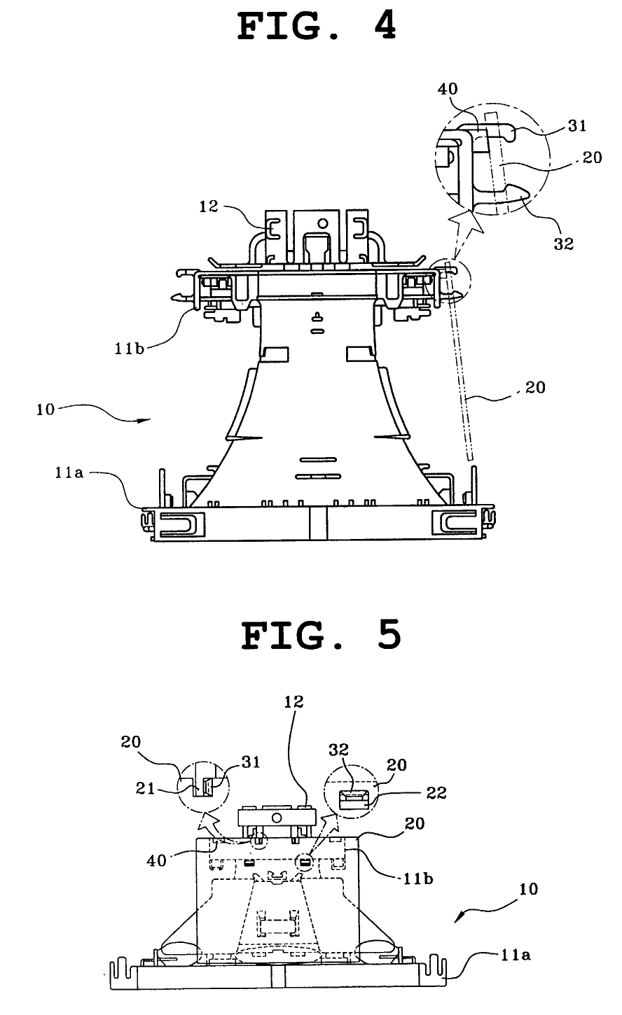

FIGS. 4 and 5 illustrate the assembled posture of a PCB in a deflection yoke of the invention, in which the same reference numerals are used to designate the same or similar components as in FIG. 1.

First, as shown in FIG. 1, the deflection yoke 4 has a substantially cone-shaped coil separator 10, in which the coil separator 10 comprises a screen section 11a with a large diameter coupled to one side of the screen surface 2 of the CRT 1, a rear cover 11b and a neck section 12. The neck section 12 is integrally extended from a central face of the rear cover 11b to couple with the electron gun section 3 of the CRT 1.

Such a coil separator 10 is provided in the inner periphery with the horizontal deflection coil 15 for generating the horizontal magnetic deflection due to the external power source and in the outer periphery with the vertical deflection coil 16 also for generating the vertical deflection coil 16 for generating the vertical magnetic deflection due to the external power source. The horizontal deflection coil 15 and the vertical deflection coil 16 are mutually insulated while positioned in place.

In the outer periphery of the coil separator 10, the magnetic ferrite core 14 is constructed to surround the vertical deflection coil 16 to strengthen the magnetic deflections.

The deflection yoke 4 constructed as above is provided with a PCB for electrically connecting various electric equipments such as the horizontal deflection coil 15 and the vertical deflection coil 16.

In this case, the PCB is fixed by fixtures provided at sides of the rear cover as shown in FIGS. 4 and 5, in which the fixtures are constituted of a number of upper and lower hook pieces.

That is to say, as can be seen in the drawings, the PCB 20 fixed by the fixtures is so constructed to have U-shaped slide grooves 21 connected to the edge of the upper part of the PCB 20 and having a predetermined interval from each other and substantially quadrangle-shaped through-holes spaced downward from the slide grooves 21 with a predetermined distance.

In this case, the interval between the pair of slide grooves 21 is so formed not to exceed the diameter of the neck section 12, and the pair of through-holes 22 are formed in positions that do not exceed the diameter of the neck section 12 also.

The PCB 20 as set forth above is coupled by fitting with the fixtures, i.e. the number of upper hook pieces 31 and the lower hook pieces 32, which are provided at the sides of the rear cover 11b. The upper hook pieces 31 and the lower hook pieces 32 are formed at such positions corresponding to the slide grooves 21 and the through-holes 22 of the PCB 20.

In the meantime, in the sides of the rear cover 11b having the upper hook pieces 31 and the lower hook pieces 32, project a plurality of support pieces 40 which are substantial characteristic components of the invention. The support pieces 40, as shown in FIG. 5, are integrally provided at the sides of the rear cover 11b, from which the upper and lower hook pieces 31 and 32 project, in positions where they can respectively support both sides of the upper part of the PCB 20.

The pair of support pieces 40 project so much that they can contact with one side of the PCB 20 as shown in FIG. 4, in which the distal ends thereof preferably form flat faces so as to contact with the PCB 20 with large areas.

In the meantime, the support pieces 40 are provided in the positions adjacent to the edge of the rear cover 11b at both sides of the fixtures, substantially exceeding the diameter of the neck section 12. As the support pieces 40 are provided adjacent to the edge of the rear cover 11b, the edge of the PCB 20 is applied with a supporting force from the support pieces 40.

In the meantime, although the support pieces 40 are illustrated as a pair of projections, the present invention is not restricted by the above construction. However, it shall be understood that the configuration and position of the support pieces 40 can be variously modified as long as they have structural characteristics which can apply secure supporting force to the upper both sides of the PCB 20 while buffering the assembling force of the PCB 20.

Hereinafter brief description will present a process of assembling the PCB in the deflection yoke of the invention as set forth above.

First, the PCB 20 is arranged at the side of the rear cover 11b having the upper and lower hook pieces 31 and 32. It is required to place the PCB 20 so that the upper and lower hook pieces 31 and 32 can be inserted into the slide grooves 21 and the through-holes 22.

Then, as the PCB 20 is moved toward the rear cover 11b, the upper and lower hooks 31 and 32 are respectively fit into the slide grooves 21 and the through-holes 22 so that the PCB 20 is fixed on the rear cover 11b.

In the meantime, the supporting force from the pair of supporting pieces 40 provided at the both distal ends in the sides of the rear cover 11b is applied to the PCB 20 so as to prevent the damage due to the external force applied to the both upper ends of the PCB 20 in assembling the same.

That is to say, since the pair of supporting pieces 40 are so constructed that the distal ends thereof closely contact with one side of the PCB 20, the supporting force reduces the external force applied to the both upper ends of the PCB 20 in assembling the same, resultantly preventing any deformation or damage of the PCB 20 due to the assembling force.

According to the deflection yoke of the invention as constructed above, the PCB is widely supported by the plurality of support pieces provided at the sides of the rear cover, and thus can be relieved from the damage due to the assembling force when it is assembled.

Therefore, the invention improves the assembling ability of the PCB so as to provide an advantageous effect of enhancing the productivity.

What is claimed is:

1. A deflection yoke comprising:
a coil separator having a screen section, a rear cover, said screen section and said rear cover being coupled to one side of a screen surface of a CRT, and a neck section extended from a central face of said rear cover for coupling with an electric gun section of said CRT;
horizontal and vertical deflection coils provided in inner and outer peripheries of said coil separator for generating horizontal and vertical magnetic deflections;
a plurality of fixtures projecting from sides of said rear cover with intervals proportional to the diameter of said neck section;
a PCB having a plurality of holes in positions corresponding to said fixtures for receiving the same, said PCB electrically connecting said horizontal deflection coils and said vertical deflection coils; and
a plurality of support pieces projecting from the sides of said rear cover having said fixtures projecting there from and with projected distal ends contacting with a side of said PCB for applying a supporting force.

2. The deflection yoke according to claim 1, wherein said fixtures are upper and lower hook pieces, said lower hook pieces being arranged under said upper hook pieces with a vertical interval.

3. The deflection yoke according to claim 1, wherein said plurality of holes in said PCB are slide-grooves recessed from edges and through-holes arranged under said slide grooves with an interval.

4. The deflection yoke according to claim 1, wherein said support pieces are provided in positions adjacent to edges of said rear cover at sides of said fixtures.

5. The deflection yoke according to claim 1, wherein said support pieces are provided in a pair for respectively supporting both sides of an upper part of said PCB.

6. The deflection yoke according to claim 1, wherein said support pieces are integral to said rear cover.
